(19) United States
(12) Patent Application Publication
(10) Pub. No.: US 2008/0091335 A1
(43) Pub. Date: Apr. 17, 2008

(54) Knock determining device and method for internal combustion engine

(75) Inventors: Yuuichi Takemura, Anjo-city (JP); Shuhei Oe, Kariya-city (JP); Rihito Kaneko, Nishikamo-gun (JP); Kenji Kasashima, Toyota-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP); TOYOTA JIDOSHA KABUSHIKI KAISHA, Toyota-city (JP)

(21) Appl. No.: 11/907,333

(22) Filed: Oct. 11, 2007

(30) Foreign Application Priority Data
Oct. 12, 2006 (JP) 2006-278315

(51) Int. Cl. G01L 23/22

(52) U.S. Cl. 701/111; 73/35.09

(57) ABSTRACT

A band pass filter processing extracts the vibration component (frequency component) of the 1st to the 4th order frequency band from the output of the knock sensor. A primary frequency band is established as the frequency band containing the fundamental frequency (primary resonance frequency) which is the lowest frequency of the knocking vibration frequencies. The 2nd to the 4th order frequency band is established as the frequency band containing the 2nd to the 4th order resonance frequency. Based on the vibration strength of the primary frequency component, the comparison result between the composite vibration waveform which compounded the 1st to the 4th order frequency component and the ideal knock waveform, and the vibration strength of the summation of the 1st to the 4th order frequency component, the noise and knocking are distinguished from each other with sufficient accuracy.

### CROSS-REFERENCE TO RELATED APPLICATION

This application is based on Japanese Patent Application No. 2006-278315 filed on Oct. 12, 2006, the disclosure of which is incorporated herein by reference.

### FIELD OF THE INVENTION

The present invention relates to a knock determining device and method for an internal combustion engine which determines whether a knock exists or not based on an output of the vibration sensor which detects a knocking vibration of the internal combustion engine.

### BACKGROUND OF THE INVENTION

Generally, the knock determining device of the internal combustion engine has the knock sensor attached to the cylinder block of the internal combustion engine, and extracts the vibration component of the predetermined frequency band from the output of this knock sensor with the band pass filter. A knock determination is performed by comparing the peak value and integral value (that is, information on vibration strength) of the vibration component of this predetermined frequency band with the knock determination threshold.

However, since the driving noise of the fuel injection valve of cylinder injection engine, and the driving noise of the variable valve timing device are increasing, it is difficult to distinguish the knocking from the noise accurately.

So, in the determining device described in JP-2005-307753A (U.S. Pat. No. 7,043,353B2), the noise and knocking are distinguished from each other with sufficient accuracy by comparing a vibration waveform detected by the knock sensor and a predetermined stored knock waveform (vibration waveform peculiar to knocking).

As shown in FIG. 3, when the generation interval of two or more noises becomes short so that two or more noises may overlap, the composite vibration waveform of these overlapping noises may become wave shape similar to the knock waveform incidentally. For example, in a dual injection engine equipped with the fuel injector for inlet port injections, and the fuel injector for cylinder injections, the injection period (valve opening period) of the fuel injector for cylinder injections becomes short, and the noise generated at the time of valve opening of the fuel injector for cylinder injections and the noises generated at the time of valve closing overlap. This vibration waveform of these overlapping noises may become wave shape similar to the knock waveform.

Thus, when the vibration waveform of the noise becomes wave shape similar to the knock waveform, even if the detected vibration waveform is compared with the knock waveform memorized previously, the noise and knocking may not be distinguished accurately. It may be erroneously determined that there is a knocking in spite of no knocking.

The present invention is made in view of the above matters. An object of the present invention is to provide a knock determining device for an internal combustion engine which is able to distinguish knocking from noise with sufficient accuracy and of which knock decision precision is improved, even when the vibration waveform of the noise becomes wave shape similar to the knock waveform.

According to the present invention, a knock determining device includes a vibration sensor, a filter which extracts the vibration component of a plurality of frequency bands, and a knock detector which determines an existence of knocking based on the vibration component of a plurality of frequency bands. The filter extracts the vibration component of a fundamental frequency band containing at least a fundamental frequency which is the lowest frequency of knocking vibration frequencies from the output of the vibration sensor. The knock detector determines the existence of knocking based on a comparison result between a vibration waveform extracted from the vibration sensor and a previously stored vibration waveform, a vibration strength of the fundamental frequency band, and a vibration strength of a summation of a plurality of frequency bands.

When knocking occurs, the vibration component of the fundamental frequency (for example, 6-9 kHz) which is the lowest frequency of the resonance frequency depending on a bore diameter of the cylinder is certainly contained. On the other hand, when the vibration waveform of each noise declines rapidly compared with knocking, a plurality of noises overlap and the composite vibration waveform of the noise becomes wave shape similar to the knock waveform. Thus, generally the rapidly attenuating vibration component of the noise appears in the high frequency side (for example, 10 kHz or more) rather than the fundamental frequency of knocking.

Even if the vibration waveform of the noise becomes wave shape similar to the knock waveform, the noise and knocking are distinguishable with sufficient accuracy based on the comparison result between the stored vibration waveform and the extracted vibration waveform, and the vibration strength of the fundamental frequency band. Furthermore, the existence of knocking can be determined with sufficient accuracy by using the vibration strength of the summation of a plurality of frequency bands.

### BRIEF DESCRIPTION OF THE DRAWINGS

FIG. 1 is a schematic view showing an engine control system according to a first embodiment.

FIG. 2 is a flowchart showing a process of a knock determination program according to first embodiment.

FIG. 3 is a chart for explaining a condition in which the vibration waveform of a noise became wave shape similar to the knock waveform.

FIG. 4 is a flowchart showing a process of a knock determination program according to second embodiment.

### DETAILED DESCRIPTION OF THE PREFERRED EMBODIMENTS

### First Embodiment

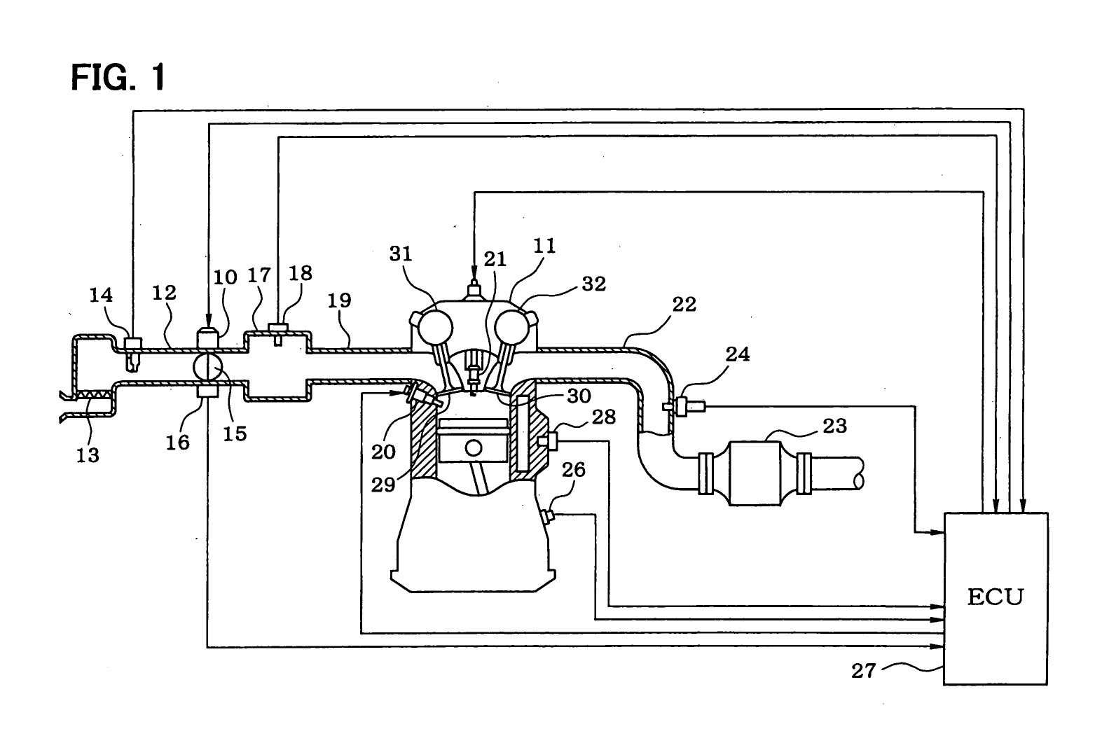

Referring to FIGS. 1 to 3, a first embodiment of the present invention will be described hereinafter.

First, based on FIG. 1, a schematic configuration of the engine control system is explained. An air cleaner 13 is arranged upstream of an intake pipe 12 of an internal combustion engine 11. An airflow meter 14 detecting an intake air flow rate is provided downstream of the air cleaner 13. A throttle valve 15 driven by a DC-motor 10 and a throttle position sensor 16 detecting a throttle position are provided downstream of the air flow meter 14.

A surge tank 17 including an intake air pressure sensor 18 is provided down steam of the throttle valve 15. The intake air pressure sensor 18 detects intake air pressure. An intake manifold 20 is connected to the surge tank 17. A fuel injector 20 is mounted on each cylinder at a vicinity of an intake air port. A spark plug 21 is mounted on a cylinder head of the engine 11 corresponding to each cylinder to ignite air-fuel mixture in each cylinder.

The engine 11 is provided with an intake valve timing controller 31 which adjusts valve timing of the intake valve 29, and an exhaust valve timing controller 32 which adjusts valve timing of an exhaust valve 30.

An exhaust pipe 22 of the engine 11 is provided with a three-way catalyst 23 purifying CO, HC, NOx in the exhaust gas. An exhaust gas sensor 24 such as an air-fuel ratio sensor and an oxygen sensor is disposed upstream of the three-way catalyst 25 and detects air-fuel ratio of the exhaust gas.

A coolant temperature sensor 25 detecting a coolant temperature, a knock sensor 28 detecting a knock vibration and a crank angle sensor 26 outputting a pulse signal every predetermined crank angle of a crankshaft of the engine 11 are disposed on a cylinder block of the engine 11. The crank angle and an engine speed are detected based on the output signal of the crank angle sensor 26.

The outputs from the above sensors are inputted into an electronic control unit 27, which is referred to an ECU hereinafter. The ECU 27 includes a microcomputer which executes an engine control program stored in a ROM (Read Only Memory) to control a fuel injection quantity and an ignition timing according to an engine running condition.

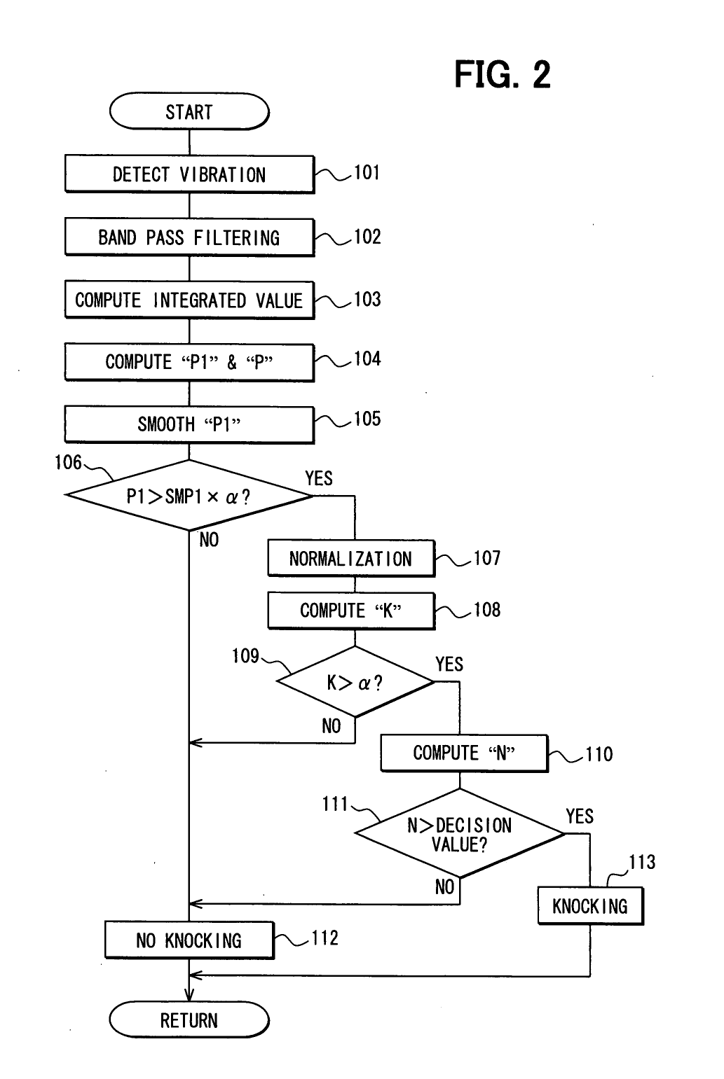

Moreover, the ECU27 executes the knock determination program shown in FIG. 2, and performs knock determination as follows. First, the vibration component of the primary frequency band (fundamental-frequency band) and the vibration component of the 2nd order to the 4th order frequency band are extracted from the output of the knock sensor 28 by performing the 1st to 4th band pass filter processing to the output of the knock sensor 28. Here, the primary frequency band (that is, pass band of the 1st band pass filter) is established as the frequency band containing the fundamental frequency (the primary resonance frequency decided by the bore diameter of the cylinder, for example, 6-9 kHz) of the frequencies of the knocking vibration which is lowest frequency. Moreover, the 2nd order to the 4th order frequency band (that is, pass band of the 2nd to 4th band pass filter) is established as the frequency band which contains the 2nd order to the 4th order resonance frequency, respectively.

And it obtains a comparison result between the ideal knock waveform (oscillatory wave form showing the waveform peculiar to the knock) and the composite vibration waveform which compounds the vibration component (“frequency component”) of the 1st order to the 4th order frequency bands, The existence of knocking is determined based on the comparison result, the vibration strength of the primary frequency component, and the vibration strength of the sum of the 1st order to the 4th order frequency component.

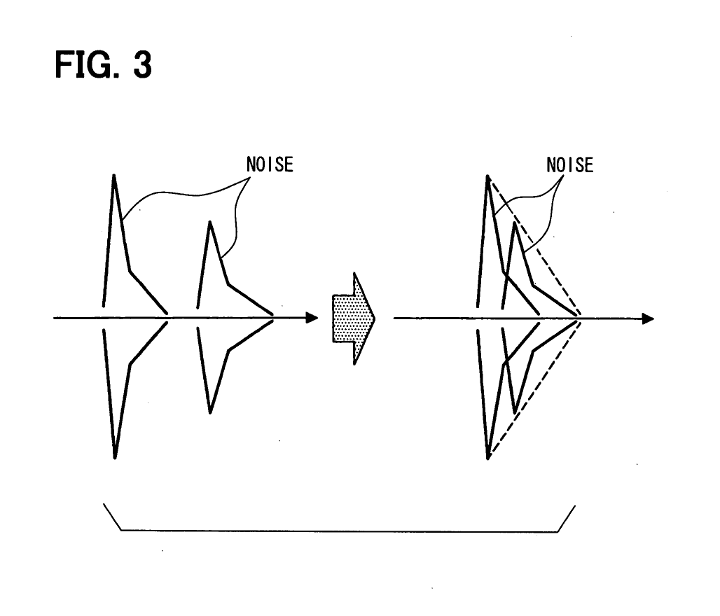

As shown in FIG. 3, when the generation interval of a plurality of noises becomes short and a plurality of noises overlap, the composite vibration waveform of these overlapping noises may become a similar wave shape of the knock waveform incidentally. When knocking occurs, the vibration component of fundamental frequency (for example, 6-9 kHz) is certainly contained. On the other hand, when a plurality of noises are overlapped and the vibration waveform of the noise is similar to the knock waveform, the impulse noise which the vibration waveform of each noise decreases rapidly compared with knocking. The vibration component of the noise decreased rapidly in this way appears in the high frequency side (for example, 10 kHz or more) rather than the fundamental frequency of knocking. Moreover, since the vibration component of the noise of the same frequency band as the fundamental frequency of knocking has gradual attenuation compared with knocking, it is easy to distinguish the knock from the noise by its wave shape.

Therefore, even when the vibration waveform of the noise becomes wave shape similar to the knock waveform, the noise and knocking are accurately distinguishable based on the vibration strength of the primary frequency component (vibration component of the fundamental frequency band), and the comparison result between the ideal knock waveform and the composite vibration waveform which compounded the 1st order to the 4th order frequency component. Furthermore, the existence of knocking can be determined with sufficient accuracy by using the vibration strength of the sum of the 1st order to the 4th order frequency component.

Hereinafter, the process of the knock determination program of FIG. 2 is explained.

The knock determination program shown in FIG. 2 is executed in a predetermined cycle while the ECU 27 is energized. In step 101, a vibration of the cylinder block of the engine 11 is detected based on the output of the knock sensor 28. This vibration detection is performed in the predetermined period (for example, period of 90° CA after the top dead center) of the combustion stroke.

Then, the procedure progresses to step 102 in which 1st to 4th band pass filter processing is performed to the output of the knock sensor 28 in order to extract the 1st to 4th frequency component from the output of the knock sensor 28.

Then, the procedure proceeds to step 103 in which an integrated value which integrates the 1st to the 4th order frequency component extracted from the output of the knock sensor 28 to every specified crank angle (for example, 5° CA) by the specified crank angle (for example, 5° CA) is computed. And the integrated values for every specified crank angle of the 1st order to the 4th order frequency component are totaled, and the composite vibration waveform is generated.

Then, the procedure proceeds to step 104 in which the largest peak value P1 (value made equivalent to the vibration strength of the primary frequency component) of the integrated values of the primary frequency component is computed. And largest peak value P (value equivalent to the vibration strength of the sum of the 1st order to the 4th order frequency component) of the composite vibration waveforms which totaled the integrated value of the 1st order to the 4th order frequency component is computed.

Then, the procedure proceeds to step 105 in which the peak value P1 of this primary frequency component is smoothed according to the following equation to compute a smoothed value SMP1(i) of the peak value of this primary frequency component, whereby the average value or the medium value of the peak value of the primary frequency component is approximately computed.

SMP1(i)=SMP1(i−1)+K×{P1−SMP1(i−1)}

wherein the SMP1(i−1) is a smoothed value of the previous peak value, and K is a smoothing coefficient.

Then, the procedure proceeds to step 106 in which an increment degree of the vibration strength of the primary frequency component is determined by determining whether the this peak value P1 is larger than a decision value which is obtained by performing multiplication of the specified value α to value SMP1. If the vibration strength of the primary frequency component increases, the peak value P1 of the primary frequency component will become large relative to the smoothed value SMP1. It is determined whether the peak value P1 of the primary frequency component is larger than the decision value. Thereby, the increment degree of the vibration strength of the primary frequency component can be accurately determined.

When it determined that the peak value P1 is lower than the decision value in step 106, the increment degree of the vibration strength of the primary frequency component is below the specified value α. The procedure proceeds to step 112 in which it is determined that no knock is generated to advance the ignition timing. Hence, when the vibration waveform of the noise becomes wave shape similar to the knock waveform, it can prevent performing an erroneous determination of knocking in spite of no knocking.

On the other hand, in step 106, when it is determined that the peak value P1 is larger than the decision value, the increment degree of the vibration strength of the primary frequency component is large and the computer determines that a knocking may have occurred. The procedure proceeds to step 107 in which the composite vibration waveform which totals the integrated value for every specified crank angle of the 1st to the 4th order frequency component is normalized.

Here, the normalization expresses a processing in which the total value of integral values of 1st to 4th order frequency component for every predetermined angle is divided by the peak value P so that the intensity of vibration is expressed by the nondimensional number (for example, nondimensional number of 0-1). Besides, the method of normalization is not limited to this. For example, it may be made to divide the sum of the integrated value for every specified crank angle of the 1st order to the 4th order frequency component by the sum of the integrated value in the peak position, respectively. Since this normalization can perform the comparison between the ideal knock waveform and the detected composite vibration waveform regardless of the intensity of vibration, it is not necessary to memorize the ideal knock waveform corresponding to the intensity of vibration, and preparation of the ideal knock waveform becomes easy.

Then, procedure progresses to step 108 in which the configuration correlation coefficient K showing the agreement degree of the detected composite vibration waveform (composite vibration waveform after normalization) and the ideal knock waveform is computed as follows. First, the timing (that is, peak position) at which vibration strength becomes the maximum in the detected composite vibration waveform, and the timing at which vibration strength becomes the maximum in the ideal knock waveform are coincided. In this condition, an absolute-value ΔS of the deviation between the composite vibration waveform detected by every specified crank angle (for example, 5° CA) and the ideal knock waveform is computed.

Then, the configuration correlation coefficient K is computed from the following formula using the total ΣΔS of ΔS in the predetermined period (for example, section from the top dead center to 90° CA), and the integral value S of the ideal knock waveform in the predetermined period (that is, area of the ideal knock waveform).

K=(S−ΣΔS(I))/S

The agreement degree (similarity) of the detected composite vibration waveform and the ideal knock waveform can be objectively evaluated. Moreover, it can be analyzed from the attenuation tendency of vibration whether it is vibration at the time of knocking by comparing the detected composite vibration waveform with the ideal knock waveform.

Then, the procedure proceeds to step 109 in which it is determined whether the configuration correlation coefficient K is larger than the specified value α. When the answer is NO in step 109, the procedure proceeds to step 112 in which the computer determines that no knocking is generated to advance the ignition timing.

When the answer is YES in step 109, the procedure proceeds to step 110 in which a knock intensity N is obtained according to the following equation.

N=P×K/BGL

wherein BGL represents a vibration intensity of the engine in a case of no knocking.

Thereby, in addition to the agreement degree of the detected composite vibration waveform and the ideal knock waveform, based on vibration strength, it can be analyzed more in the detail whether vibration of the engine 11 is vibration resulting from knocking.

Then, the procedure proceeds to step 111 in which it is determined whether the knock intensity N is larger than the knock decision value. When the answer is NO is step 111, the procedure proceeds to step 112.

When the answer is YES in step 111, the procedure proceeds to step 113 in which the computer determines that knocking is generated to retard the ignition timing. Thereby, the knocking is restricted.

In first embodiment, when the vibration waveform of the noise becomes wave shape similar to the knock waveform, it is noted that the vibration component of the noise is high frequency rather than the fundamental frequency of knocking. And since the vibration strength (peak value P1) of the primary frequency component and the comparison result (configuration correlation coefficient K) of the composite vibration waveform and the ideal knock waveform are used on the occasion of knock determination, even when the vibration waveform of the noise becomes wave shape similar to the knock waveform, the noise and knocking can be accurately distinguished from each other. Furthermore, the existence of knocking can be accurately determined by using the vibration strength (peak-value P of the composite vibration waveform) of the sum of the 1st to the 4th order frequency component.

And in the system equipped with the fuel injection valve 20, and the variable valve timing devices 31, 32, it is becoming difficult to distinguish the noise and knocking with sufficient accuracy. However, by using the knock determination method of the first embodiment, the noise and knocking can be distinguished with sufficient accuracy and knock decision precision can be raised.

Moreover, according to the first embodiment, the increment degree of the vibration strength of the primary frequency component is determined by comparing the peak value P1 of the primary frequency component with the smoothed value SMP1. The average value or medium value of the peak value of the primary frequency component is computed in approximation by performing smoothing processing of the peak value P1, and calculating smoothed value SMP1 of the peak value of this primary frequency component.

In computing the average value and medium value of the peak value P1 of the primary frequency component as the definitional equation, a large memory which memorizes a lot of data is needed, and, moreover, the average value or medium value cannot be made to follow with the sufficient response to change of the vibration strength of the primary frequency component by change of an engine operation condition.

According to the first embodiment, since the average value or medium value of the peak value P1 of the primary frequency component is computed in approximation by performing smoothing processing of the peak value P1 of the primary frequency component, the memory usage is saved, the smoothed value (substitution information on the average value or medium value) can be made to follow with the sufficient response to change of the vibration strength of the primary frequency component.

In the present invention, the increment degree of the vibration strength of the primary frequency component may be determined by computing the average value and medium value of the peak value of the primary frequency component as the definitional equation, and comparing the peak value, the average value, or medium value of the primary frequency component.

Besides, the increment degree of the vibration strength of the primary frequency component may be determined by determining whether the difference of the peak value P1 of the primary frequency component and smoothed value SMP1 is larger than the specified value. The method of comparing the peak value P1 of the primary frequency component with the smoothed value SMP1, and determining the increment degree of the vibration strength of the primary frequency component may be changed suitably.

### Second Embodiment

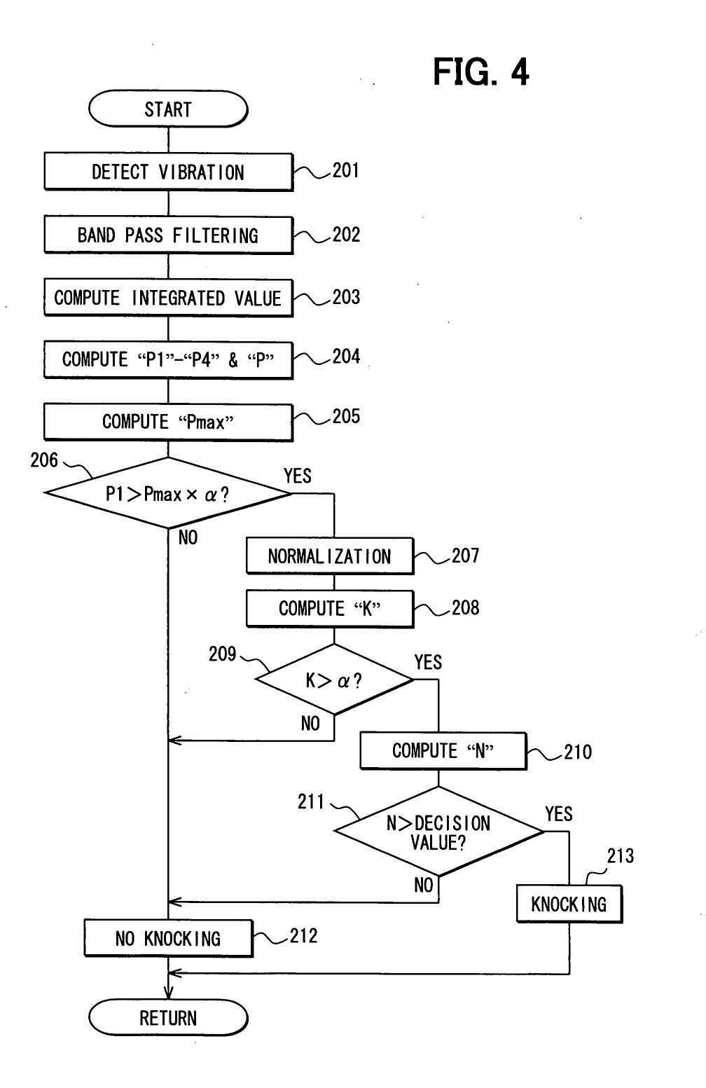

Then, a second embodiment of the present invention is explained referring to FIG. 4.

According to the second embodiment, the increment degree of the vibration strength of the primary frequency component is determined by comparing the peak value P1 of the primary frequency component with the maximum Pmax among peak values P2 to P4 of the 2nd order to the 4th frequency component by executing the knock determination program shown in FIG. 4.

In the knock determination program shown in FIG. 4, a band pass filter processing extracts the 1st to the 4th order frequency component from the output of the knock sensor 28. The integrated values which integrates the 1st to the 4th order frequency component by the specified crank angle for every specified crank angle, respectively is computed. The integrated value for every specified crank angle of the 1st to the 4th order frequency component is totaled, and the composite vibration waveform is generated (steps 201-203).

Then, the procedure proceeds to step 204 in which peak values P1-P4 of the integrated value are computed with respect to the 1st to the 4th order frequency component, respectively. And the peak value P of the composite vibration waveform which totals the integrated value of the 1st to the 4th order frequency component is computed.

Then, the procedure proceeds to step 205 in which the maximum Pmax out of the peak values P2-P4 of the frequency components other than primary (that is, from the 2nd to 4th order) is computed. In step 206, the increment degree of the vibration strength of the primary frequency component is determined by determining whether the peak value P1 of this primary frequency component is larger than the decision value which is obtained by performing multiplication of the specified value α to the maximum value Pmax. That is, when the vibration strength of the primary frequency component increases, the peak value P1 of the primary frequency component will become larger than the peak values P2-P4 of the 2nd to the 4th frequency component. Hence, the increment degree of the vibration strength of the primary frequency component can be determined with sufficient accuracy by determining whether the peak value P1 of the primary frequency component is larger than the decision value which obtained by performing multiplication of the specified value to the maximum value Pmax.

When the answer is NO in step 206, the procedure proceeds to step 212 in which the computer determines that no knocking is generated to advance the ignition timing.

When the answer is YES in step 206, the computer determines that a knocking is generated, The procedure proceeds to step 207 in which the composite vibration waveform which totals the integrated value for every specified crank angle of the 1st to the 4th order frequency component is normalized. Then, the procedure proceeds to step 208 in which the configuration correlation coefficient K, which expresses the agreement degree of the detected composite vibration waveform (composite vibration waveform after normalization) and the ideal knock waveform, is computed.

Then, the procedure proceeds to step 209 in which it is determined whether the configuration correlation coefficient K is larger than the specified value β. When the answer is NO is step 209, the procedure proceeds to step 212 in which the computer determines no knocking is generated.

When the answer is YES in step 209, the procedure proceeds to step 210 in which the knock intensity N is computed. Then, in step 211, it is determined whether the knock intensity N is larger than the knock determination value.

When the answer is NO is step 211, the procedure proceeds to step 212 in which the computer determines no knocking is generated. When the answer is YES in step 211, the procedure proceeds to step 213 in which the computer determines a knocking is generated to retard the ignition timing.

The second embodiment can also acquire the same advantage as the first embodiment.

Besides, in the above mentioned second embodiment, the increment degree of the vibration strength of the primary frequency component is determined by determining whether the peak value P1 is larger than the decision value. Alternatively, the increment degree of the vibration strength of the primary frequency component may be determined by determining whether the difference of the peak value P1 of the primary frequency component and the maximum Pmax is larger than the specified value. The method of determining the increment degree of vibration strength is changed suitably.

Moreover, in the first and the second embodiment, the 1st to the 4th order frequency components are extracted from the output of the knock sensor 28 in order to perform knock determination. However, as long as the primary frequency component is extracted, the number and range of the frequency band to extract may be changed suitably. Furthermore, the comparison method of the vibration waveform and the ideal knock waveform and the valuation method of vibration strength may be changed suitably.

Moreover, the present invention may be applied to the system equipped with the variable valve lift device in which the lift amount of the suction valve or the exhaust valve is change, or a system equipped with a variable valve angle apparatus in which the valve angle (valve opening period) of the suction valve and the exhaust valve is changed. Furthermore, the present invention may be applied to the system equipped with the two or more variable valve systems, such as the variable valve timing device, the variable valve lift device, and the variable valve angle apparatus.

Moreover, in the first and the second embodiment, the present invention is applied to cylinder injection engine. The present invention may be applied to the inlet port injection engine and the dual injection engine which is provided with the fuel injector in the inlet port and the cylinder.

What is claimed is:

1. A knock determining device for an internal combustion engine, comprising:
a vibration sensor which detects a knocking vibration of the internal combustion engine,
a filter means for extracting a vibration component of a plurality of frequency bands from the output of the vibration sensor, and
a knock determination means for determining an existence of knocking based on the vibration component of a plurality of frequency bands extracted from the output of the vibration sensor by the filter means, wherein
the filter means extracts the vibration component of a fundamental frequency band containing at least a fundamental frequency which is the lowest frequency of knocking vibration frequencies from the output of the vibration sensor, and
the knock determination means determines the existence of knocking based on a comparison result between a vibration waveform extracted from the output of the vibration sensor and a previously stored vibration waveform, a vibration strength of the fundamental frequency band, and a vibration strength of a summation of a plurality of frequency bands.

2. A knock determining device according to claim 1, wherein
the knock determination means includes a determination means for determining an increment degree of the vibration strength of the fundamental frequency band by comparing a current vibration strength of the fundamental frequency band with an average value or a medium value of the vibration strength of the fundamental frequency band.

3. A knock determining device according to claim 2, wherein
the knock determination means approximately computes the average value or the medium value of the vibration strength of the fundamental frequency band by performing a smoothing process of the vibration strength of the fundamental frequency band.

4. A knock determining device according to claim 1, wherein
the knock determination means has the judging means which determines the increment degree of the vibration strength of the fundamental frequency band by comparing the vibration strength of the fundamental frequency band with the vibration strength of the frequency band of the frequency higher than the fundamental frequency band.

5. A knock determining device according to claim 2, wherein
the knock determination means determines that no knocking exists, when the increment degree of the vibration strength of the fundamental frequency band is less than a specified value.

6. A knock determining device according to claim 1, further comprising:
a variable valve device which adjusts an opening-and-closing characteristic of the suction valve and/or exhaust valve of the internal combustion engine.

7. A knock determining device according to claim 1, further comprising:
a fuel injector which performs a direct fuel injection into a cylinder of the internal combustion engine.

8. A knock determining device for an internal combustion engine, comprising:
a vibration sensor which detects knocking vibration of the internal combustion engine,
a filter which extracts a vibration component of a plurality of frequency bands from the output of the vibration sensor, and
a knock detector which detects an existence of knocking based on the vibration component of a plurality of frequency bands extracted from the output of the vibration sensor by the filter means, wherein
the filter extracts the vibration component of a fundamental frequency band containing at least a fundamental frequency which is the lowest frequency of knocking vibration frequencies from the output of the vibration sensor, and
the knock detector detects the knocking based on a comparison result between a vibration waveform extracted from the output of the vibration sensor and a previously stored vibration waveform, a vibration strength of the fundamental frequency band, and a vibration strength of a summation of a plurality of frequency bands.

9. A knock determining method for an internal combustion engine, comprising:
detecting knocking vibration of the internal combustion engine,
extracting the vibration component of a fundamental frequency band containing at least a fundamental frequency which is the lowest frequency of knocking vibration frequencies from the output of the vibration sensor, and
determining an existence of knocking based on a comparison result between a detected vibration waveform and a previously stored vibration waveform, a vibration strength of the fundamental frequency band, and a vibration strength of a summation of a plurality of frequency bands.
